(19) United States
(12) Patent Application Publication
(10) Pub. No.: US 2021/0129687 A1
(43) Pub. Date: May 6, 2021

(54) SYSTEM AND PROCESS FOR UTILIZING A DEPLOYABLE FLEX RANGE BATTERY TO AUGMENT A PRIMARY BATTERY

(71) Applicant: GM GLOBAL TECHNOLOGY OPERATIONS LLC, Detroit, MI (US)

(72) Inventors: Venkata Prasad Atluri, Novi, MI (US); Hanho Yun, Oakland Township, MI (US); Neeraj S. Shidore, Novi, MI (US); Chandra S. Namuduri, Troy, MI (US); Venkatesh Gopalakrishnan, Troy, MI (US)

(73) Assignee: GM GLOBAL TECHNOLOGY OPERATIONS LLC, Detroit, MI (US)

(21) Appl. No.: 16/671,999

(22) Filed: Nov. 1, 2019

(51) Int. Cl. B60L 50/60; B60L 58/18; B60L 58/12

(52) U.S. Cl. CPC B60L 50/66; B60L 58/18; B60L 2210/10; B60L 2270/20; B60L 58/12

(57) ABSTRACT

A system for utilizing a deployable flex range battery to augment a primary battery is provided. The system includes a flex electronics bay. The flex electronics bay is electrically connected to an electrical sub-system including the primary battery and includes a DC-DC converter operable to change a voltage of electric power and at least one battery connection terminal. The system further includes the deployable flex range battery removably connected to the at least one battery connection terminal and a flex electronics bay controller programmed to selectively supply electric power from the flex electronics bay to the electrical sub-system.

### INTRODUCTION

The disclosure generally relates to a system and process for utilizing a deployable flex range battery to augment a primary battery.

Battery-powered electric vehicles (BEV) utilize a rechargeable energy storage device or battery to store energy. This energy can be discharged as a voltage useful to supply electric power to one or more electric machines configured to transform electrical power into a mechanical torque to an output shaft. This mechanical torque is useful to drive one or more wheels of the vehicle which supplies motive force to the vehicle. Such electric machines can similarly recover or transform energy from mechanical sources, such as excess speed in the vehicle, into electrical energy which can be stored.

BEV range is limited by available stored energy. If a single available energy storage device, such as an exemplary battery device, has an exemplary maximum energy storage capacity of 15 kWh, that capacity can be utilized by the electric machine of the BEV to provide motive force to the vehicle. Once that battery device is depleted, the vehicle can no longer be driven.

### SUMMARY

A system for utilizing a deployable flex range battery to augment a primary battery is provided. The system includes a flex electronics bay. The flex electronics bay is electrically connected to an electrical sub-system including the primary battery and includes a DC-DC (direct current to direct current) converter operable to change a voltage of electrical power and at least one battery connection terminal. The system further includes the deployable flex range battery removably connected to the at least one battery connection terminal and a flex electronics bay controller programmed to selectively supply electric power from the flex electronics bay to the electrical sub-system.

In some embodiments, the system includes a motor generator unit operable to provide a motive force to the battery-powered electric vehicle and the electrical sub-system including the primary battery operable to supply electric power to the motor generator unit.

In some embodiments, the flex electronics bay includes a plurality of battery connection terminals, and the system further includes a plurality of the deployable flex range batteries.

In some embodiments, the flex electronics bay further includes a plurality of electronically controllable switches operable to selectively electronically engage and selectively electronically disengage each of the plurality of deployable flex range batteries.

In some embodiments, the flex electronics bay further includes a pre-charge circuit for each of the electronically controllable switches, the pre-charge circuits being operable to bring the deployable flex range batteries online while minimizing in-rush currents.

In some embodiments, the flex electronics bay controller further includes programming to monitor a status of each of the deployable flex range batteries, diagnose a malfunction in one of the deployable flex range batteries based upon the monitored status, and control one of the plurality of electronically controllable switches to selectively disengage the one of the deployable flex range batteries.

In some embodiments, the flex electronics bay controller further includes programming to supply electric power from the flex electronics bay to the electrical sub-system when the vehicle is parked.

In some embodiments, the flex electronics bay controller further includes programming to supply electric power from the flex electronics bay to the electrical sub-system when the vehicle is moving.

In some embodiments, the flex electronics bay controller further includes programming to evaluate a state of charge of the primary battery required to operate the battery-powered electric vehicle, and wherein selectively providing power from the flex electronics bay to the electrical sub-system is based upon an evaluation that the state of charge of the primary battery is insufficient to operate the battery-powered electric vehicle.

In some embodiments, evaluating the state of charge of the primary battery required to operate the battery-powered electric vehicle includes monitoring a planned travel destination, estimating a total travel distance based upon the planned travel destination, and estimating a state of charge required based upon the total travel distance.

In some embodiments, selectively providing power from the flex electronics bay to the electrical sub-system includes utilizing a first portion of a plurality of deployable flex range batteries of the flex electronics bay to supply electric power to the electrical sub-system and isolating a second portion of the plurality of deployable flex range batteries of the flex electronics bay for later use.

In some embodiments, the deployable flex range battery includes a battery management system including a computerized device programmed to monitor operation of the deployable flex range battery.

In some embodiments, the system further includes a plurality of the deployable flex range batteries, wherein each deployable flex range battery includes a battery management system including a computerized device programmed to monitor operation of the deployable flex range battery and wherein each battery management system is in electronic communication with the flex electronics bay controller.

In some embodiments, each of the battery management system is in wireless electronic communication with the flex electronics bay controller.

In some embodiments, the system further includes a plurality of the deployable flex range batteries and the flex electronics bay further includes a plurality of DC-DC converters, wherein each of the plurality of DC-DC converters is paired with one of the plurality of deployable flex range batteries.

In some embodiments, the flex electronics bay controller further includes programming to monitor availability of a fast charge infrastructure site, determine an excess primary battery charge available based upon the monitored availability, and selectively supplying power from the primary battery to the deployable flex range battery based upon the excess primary battery charge.

According to one alternative embodiment, a system for utilizing a plurality of deployable flex range batteries to augment a primary battery in a battery-powered electric vehicle is provided. The system includes a motor generator unit operable to provide a motive force to the battery-powered electric vehicle, an electrical sub-system including the primary battery operable to supply electric power to the motor generator unit, the plurality of deployable flex range batteries, wherein each deployable flex range battery includes a battery management system including a computerized device programmed to monitor operation of the deployable flex range battery, and a flex electronics bay electrically connected to the electrical sub-system. The flex electronics bay includes a DC-DC converter operable to change a voltage of electrical power, a plurality of battery connection terminals, a plurality of electronically controllable switches operable to selectively electronically engage and selectively electronically disengage each of the plurality of deployable flex range batteries, and a pre-charge circuit for each of the electronically controllable switches, the pre-charge circuits being operable to bring the deployable flex range batteries online while minimizing in-rush currents. The system further includes a flex electronics bay controller, programmed to selectively supply electric power from the flex electronics bay to the electrical sub-system. Each battery management system is in electronic communication with the flex electronics bay controller. Each of the plurality of deployable flex range batteries is removably connected to one of the plurality of battery connection terminals.

According to one alternative embodiment, a process for utilizing one or more deployable flex range batteries to augment a primary in a battery-powered electric vehicle is provided. The process includes supplying electrical power from an electrical sub-system including the primary battery to a motor generator unit operable to provide a motive force to the battery-powered electric vehicle, connecting a plurality of deployable flex range batteries to a flex electronics bay of the battery-powered electric vehicle, and, within a computerized flex electronics bay controller, operating programming to monitor a status of each of the plurality of deployable flex range batteries, determine a schedule to utilize stored energy within each of the plurality of deployable flex range batteries to supply power to the electrical sub-system based upon the monitored statuses, and selectively supply power from the flex electronics bay to the electrical sub-system based upon the schedule.

In some embodiments, determining the schedule to utilize the stored energy includes determining a schedule to utilize stored energy from each of the deployable flex range batteries individually.

In some embodiments, the computerized flex electronics bay controller further includes programming to diagnose a malfunction in one of the deployable flex range batteries based upon the monitored statuses and selectively disengage the one of the deployable flex range batteries.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary system for utilizing one or more deployable flex range batteries to augment a primary battery in a battery-powered electric vehicle, in accordance with the present disclosure;

FIG. 2 schematically illustrates the flex electronics bay of FIG. 1 in greater detail, in accordance with the present disclosure;

FIG. 3 schematically illustrates internal components of an exemplary deployable flex range battery, in accordance with the present disclosure;

FIG. 4 graphically illustrates exemplary operation of the disclosed electrical sub-system selectively supplying electrical power to a BEV through one or more connected deployable flex range batteries, in accordance with the present disclosure;

FIG. 5 graphically illustrates alternative exemplary operation of the disclosed electrical sub-system selectively supplying electrical power to a BEV through one or more connected deployable flex range batteries in accordance with the present disclosure;

FIG. 6 is a flowchart illustrating an exemplary process for controlling a flex electronics bay operable to selectively attach a plurality of deployable flex range batteries to an electrical sub-system of a BEV, in accordance with the present disclosure;

FIG. 7 schematically illustrates an alternative exemplary embodiment of a flex electronics bay, in accordance with the present disclosure; and

FIG. 8 is a flowchart illustrating an exemplary process to utilize a location of a fast charge infrastructure site to charge a deployable flex range battery with excess charge from a primary battery, in accordance with the present disclosure.

### DETAILED DESCRIPTION

A process and system for utilizing one or more deployable flex range batteries to augment a primary battery in a battery-powered electric vehicle.

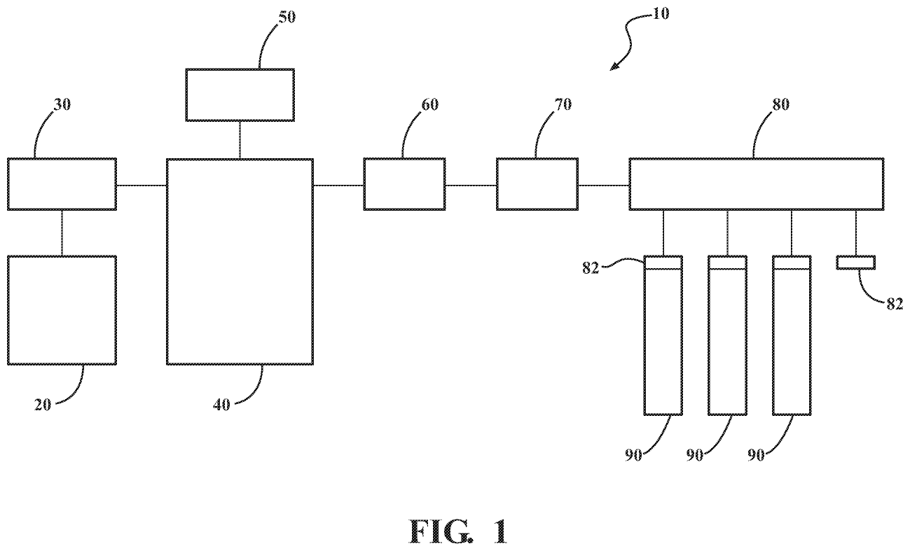

Referring now to the drawings, wherein like reference numbers refer to like features throughout the several views, FIG. 1 schematically illustrates an exemplary system for utilizing one or more deployable flex range batteries to augment a primary battery in a battery-powered electric vehicle. Vehicle electrical sub-system 10 is illustrated including motor generator unit 20, power inverter 30, primary energy storage device 40, battery maintenance system 50, onboard charger module 60, combo charge port 70, flex electronics bay 80, and a plurality of deployable flex range batteries 90. Motor generator unit 20 is an electric machine configured to bidirectionally transfer energy between electrical energy and torque applied to an output shaft of the motor generator unit 20. In one exemplary embodiment, motor generator unit 20 is configured to receive and supply power in the form of alternating current electricity. Power inverter 30 is provided to transform electrical energy from one voltage range and/or current type (alternating current and direct current) to another voltage range and/or current type. Primary energy storage device 40 can include an exemplary battery or set of batteries useful to store energy and supply on demand electrical energy. In other embodiments, fuel cells, supercapacitors, ultracapacitors, and other energy storage devices in the art can be additionally or alternatively utilized within primary energy storage device 40 to store and supply energy on demand. Battery maintenance system 50 is an electronic device that manages primary energy storage device 40, for example, by monitoring a state of charge, setting operating parameters, and managing charging of the primary energy storage device 40. Onboard charger module 60 includes electronic components configured to receive power from one source, determine power required to charge a particular energy storage device, and transform the received power into the power required to charge the energy storage device. Combo charge port 70 includes an interface configured to connect the onboard charger module 60 and flex electronics bay 80. Flex electronics bay 80 includes electronics configuration to selectively connect to one or more deployable flex range batteries 90 and transfer power between the deployable flex range batteries 90 and combo charge port 70. Flex electronics bay 80 can include a plurality of battery connection terminals 82 configured to detachably electrically connect deployable flex range batteries 90 to flex electronics bay 80. Flex electronics bay 80 can include different numbers of battery connection terminals 82. The exemplary flex electronics bay 80 of FIG. 1 includes four battery connection terminals 82, although it can have one, two, three, or twelve, and the disclosure is not intended to be limited to the particular examples provided herein.

Depending upon the planned usage of the BEV, a user can selectively attach or detach deployable flex range batteries 90 from flex electronics bay 80 to increase or decrease a range of the BEV. For example, if a user is planning a short trip, for example, to and from a neighborhood store, the user may decide to detach each of the deployable flex range batteries 90 and place them in separate infrastructure charging devices so that deployable flex range batteries 90 can be utilized later when needed with a full state of charge. In another example, where a long trip is planned, the user can install a deployable flex range battery 90 into every battery connection terminal 82, such that the BEV has as long of a range as possible. Deployable flex range batteries 90 are deployable in that they may be removable from the BEV, for example, to conserve weight when they are not needed. In another example, the deployable flex range batteries 90 can be deployable in a sense that they can be purchased, rented, borrowed, or otherwise externally obtained by a user for a particular purpose, for example, an unusually long trip, and they can be removed, returned, or stored away when not in use.

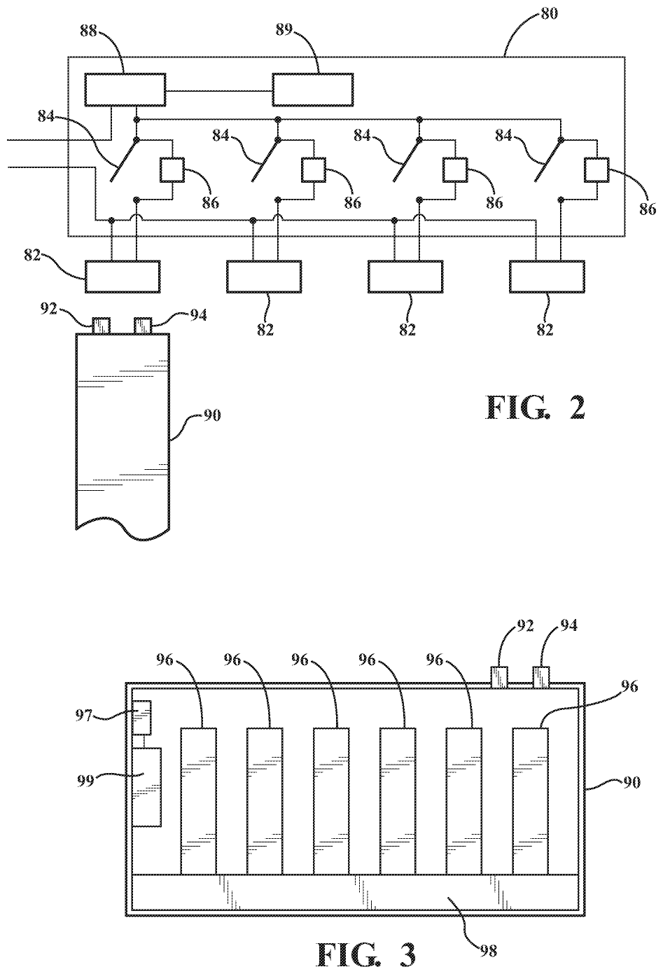

FIG. 2 schematically illustrates the flex electronics bay 80 of FIG. 1 in greater detail. Flex electronics bay 80 is illustrated including components useful to electronically connecting one or more deployable flex range batteries 90 to an electrical sub-system 10 of a battery-powered vehicle to augment a primary battery. Flex electronics bay 80 includes DC-DC converter 88; flex electronics bay controller 89; a plurality of electronically controllable switches 84, each including a pre-charge circuit 86 configured to bring additional deployable flex range batteries 90 online while minimizing in-rush currents; and a plurality of battery connection terminals 82. An exemplary deployable flex range battery 90 is illustrated including battery connection post 92 and battery connection post 94 operable to connect with mating details within one of the battery connection terminals 82.

The DC-DC converter 88 is operable to transform electrical energy from one voltage to a second voltage. DC-DC converter 88 can convert a relatively low voltage (for example, 24-48 Volts) supplied by deployable flex range batteries 90 and convert the electrical power to higher voltages (for example, 400 Volts) utilized by a BEV electrical sub-system 10.

Flex electronics bay controller 89 includes a computerized processor and includes programming operative to control the various aspects and functions of flex electronics bay 80. For example, flex electronics bay controller 89 can control electronically controllable switches 84 and pre-charge circuits 86 to selectively electronically engage and disengage connected deployable flex range batteries 90 as needed. Flex electronics bay controller 89 can additionally control DC-DC converter 88, for example, controlling output voltage and/or activating an internal cut-off switch within DC-DC converter to selectively electronically engage and disengage flex electronics bay 80 from the rest of the electrical sub-system 10 of the BEV. In one embodiment, flex electronics bay controller 89 can monitor and control systems and devices external to flex electronics bay 80, for example, monitoring a state of charge of the primary battery and controlling when and under what circumstances power is supplied by the deployable flex range batteries to the electrical sub-system 10 of the BEV. In another embodiment, flex electronics bay controller can receive inputs from external sources, for example, monitoring a planned route of travel entered by the user into an in-vehicle navigation system or a smart phone connected by wireless communication to the BEV, and the planned route including an overall distance to be traveled, required speeds and torques through different stages of the travel, and availability of locations to add or swap out deployable flex range batteries along the planned travel path can be utilized by programming of the flex electronics bay controller 89 to schedule power supply by the deployable flex range batteries. The flex electronics bay controller 89 is illustrated within flex electronics bay 80. In alternative embodiments, flex electronics bay controller 89 can exist outside of the flex electronics bay 80. In alternative embodiments, flex electronics bay controller 89 can be physically part of another controller, for example, embodied as programming enabled within an overall controller for the electrical sub-system 10 of the BEV or as part of battery maintenance system 50.

Deployable flex range batteries can include many different embodiments of battery devices, and examples provided herein are not intended to be limiting. FIG. 3 schematically illustrates internal components of an exemplary deployable flex range battery. Deployable flex range battery 90 is illustrated including a plurality of battery cells 96. The battery cells can be electronically connected in series or in parallel and are electronically connected to battery connection post 92 and battery connection post 94 and are operable to connect with mating details within a battery connection terminal of FIG. 2. In the exemplary embodiment of FIG. 3, each of battery cells 96 are connected to and thermally managed by heat exchanger tray 98 operable to provide heat to or remove heat from each of battery cells 96. In one exemplary embodiment, heat exchanger tray 98 can be provided with an internal flow of gaseous and/or liquid coolant that employs convective and evaporative cooling. In another embodiment, heat exchanger tray 98 can include solid state heating and cooling through an electronic heat pump.

Deployable flex range battery 90 may include a battery management system 99 including a computerized device useful to monitor a status of the deployable flex range battery 90. The monitored status can include information including but not limited to temperature and voltage. Battery management system 99 can utilize a communications device 97 which can include wired or wireless communication to communicate with flex electronics bay controller 89 of FIG. 2. Battery management system 99 and/or flex electronics bay controller 89 can determine parameters of deployable flex range battery 90 including but not limited to a state of charge, state of health, and power and performance limits of the battery.

Diagnostic capabilities of a flex electronics bay controller can be useful to isolate one or more connected deployable flex range batteries if they are determined to be malfunctioning. For example, if a battery is supplying an unpredictable or varying voltage, the flex electronics bay controller can activate the connected switch to deactivate or isolate the malfunctioning battery from the system.

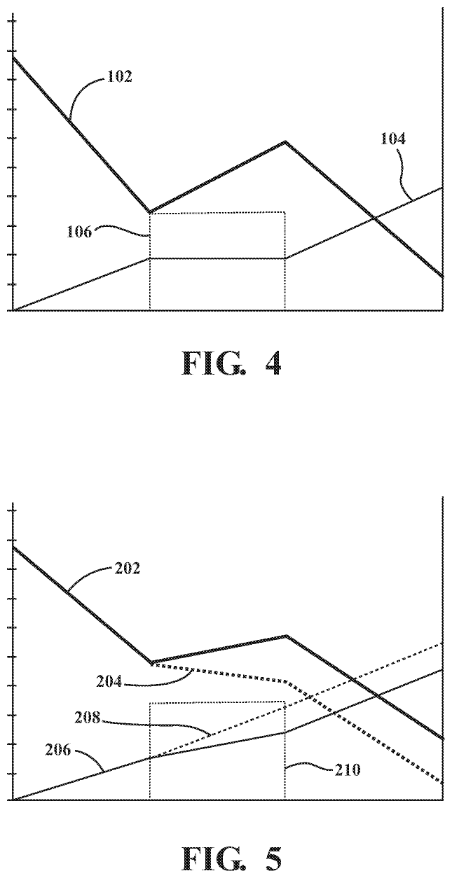

FIG. 4 graphically illustrates exemplary operation of the disclosed electrical sub-system selectively supplying electrical power to a BEV through one or more connected deployable flex range batteries. A vertical axis illustrates a battery state of charge, power supplied by deployable flex range batteries, and a cumulative driving distance traveled. A horizontal axis illustrates three sequential periods of operation, from left to right, including a first charge depleting period, a parked charge replenishing period, and a second charge depleting period. Plot 102 illustrates a primary battery state of charge. Plot 104 illustrates a cumulative driving distance traveled by the BEV. Plot 106 illustrates power supplied by the deployable flex range batteries to the electrical sub-system of the BEV.

During the first charge depleting period, the BEV travels a distance and the primary battery supplies electrical power to provide motive force to the BEV. The deployable flex range batteries do not supply electric power to the electrical sub-system during this period. As a result, a state of charge of the primary battery is reduced according to plot 102 and distance traveled by the BEV is accumulated according to plot 104.

During the parked charge replenishing period, the BEV is parked, and electrical power is supplied by the deployable flex range batteries for the purpose of recharging the primary battery. Plot 104 illustrates a constant cumulative distance traveled, meaning that the parked BEV does not accumulate new miles traveled during this period. As a result, an entirety or nearly an entirety of the power supplied by the deployable flex range batteries can be used to charge the primary battery. Plot 106 illustrates the power generated by the deployable flex range batteries increasing as a step function and supplying some constant or near constant amount of power during this period. Plot 102 illustrates the state of charge of the primary battery increasing through this period.

During the second charge depleting period, the BEV travels a distance and the primary battery supplies electrical power to provide motive force to the BEV. The power generated by the deployable flex range batteries illustrated by plot 106 has decreased back to zero, and the deployable flex range batteries do not supply electric power to the electrical sub-system during this period. As a result, a state of charge of the primary battery is reduced according to plot 102 and distance traveled by the BEV is accumulated according to plot 104.

Charging a BEV while the BEV is parked requires coordination with the driver, so that the driver can approve of a plan to permit the BEV to be parked for a time period. A computerized controller, for example, the flex electronics bay controller, can communicate either directly with the user or can communicate a request to plan a parking period for battery charging to a smart phone or other device available to the driver, such that an appropriate travel plan can developed. In one embodiment, the system can recommend that, as a time appropriate activity, the user plan a stop for a meal at a time that would traditionally be a mealtime and which also works with a plan to recharge the primary battery of the BEV. In one embodiment, the system can recommend to the user a minimum park time to accomplish a desired amount of recharging of the primary battery.

FIG. 5 graphically illustrates alternative exemplary operation of the disclosed electrical sub-system selectively supplying electrical power to a BEV through one or more connected deployable flex range batteries. A vertical axis illustrates a battery state of charge, power supplied by deployable flex range batteries, and a cumulative driving distance traveled. A horizontal axis illustrates three sequential periods of operation, from left to right, including a first charge depleting period, a charge replenishing period or low rate charge depletion period, and a second charge depleting period. Plot 202 illustrates a primary battery state of charge. Plot 206 illustrates a cumulative driving distance traveled by the BEV. Plot 210 illustrates power generated by the deployable flex range batteries and supplied to the electrical sub-system of the BEV.

During the first charge depleting period, the BEV travels a distance and the primary battery supplies electrical power to provide motive force to the BEV. The deployable flex range batteries do not supply electric power to the electrical sub-system during this period. As a result, a state of charge of the primary battery is reduced according to plot 202 and distance traveled by the BEV is accumulated according to plot 206.

During the charge replenishing period or low rate charge depleting period, the BEV continues to travel and accumulate distance traveled, and electrical power is supplied by the deployable flex range batteries for the purposes of recharging the primary battery and/or supplying power to provide motive force to the vehicle. Two alternative scenarios are illustrated. Plot 202 and plot 206 illustrate a scenario where the power generated by the deployable flex range batteries is sufficient to permit the BEV to continue traveling and still increase a state of charge of the primary battery during the travel. Plot 204 and plot 208, alternatively, illustrate a scenario where the primary battery state of charge continues to decrease, and the primary battery continues to deplete, but power generated by the deployable flex range batteries slows the rate of depletion as compared to the first charge depleting period. Plot 210 illustrates the power generated by the deployable flex range batteries increasing by a step function, and the deployable flex range batteries supplying a constant or near constant power through this period.

During the second charge depleting period, the BEV travels a distance and the primary battery supplies electrical power to provide motive force to the BEV. The power generated by the deployable flex range batteries illustrated by plot 210 has decreased back to zero, and the deployable flex range batteries do not supply electric power to the electrical sub-system during this period. As a result, a state of charge of the primary battery is reduced according to either plot 202 or plot 204 and distance traveled by the BEV is accumulated according to either plot 206 or plot 208.

While exemplary data is illustrated in FIGS. 4 and 5 showing deployable flex range batteries supplying power as a step function, it will be appreciated that different rates of power supply can be utilized.

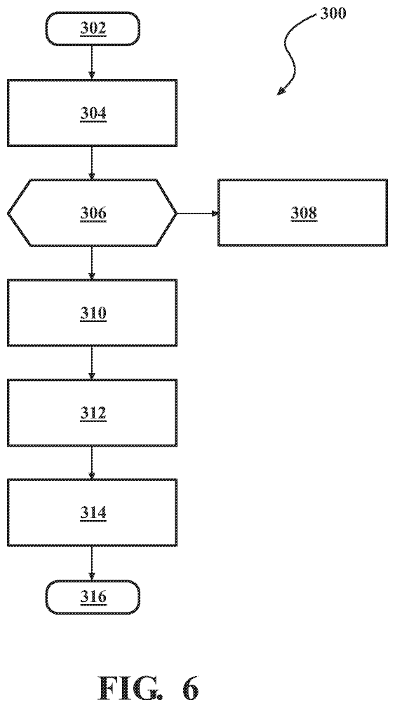

FIG. 6 is a flowchart illustrating an exemplary process for controlling a flex electronics bay operable to selectively attach a plurality of deployable flex range batteries to an electrical sub-system of a BEV. Process 300 starts at step 302. At step 304, a primary battery state of charge is monitored. Additionally, if the information is available, a distance to a planned destination can also be monitored. At step 306, a determination is made whether the primary battery includes sufficient state of charge to deliver motive power to the BEV as required by the user. If the primary battery is determined to have sufficient state of charge to meet the needs of the BEV, the process advances to step 308 where the DC-DC converter of the flex electronics bay of the BEV is put in stand by mode. If the primary battery is determined to not have sufficient state of charge to meet the needs of the BEV, the process advances to step 310, where the flex electronics bay controller calculates a DC-DC converter voltage boost set point required to accomplish desired charging of the primary battery with available deployable flex range batteries. At step 312, at an appropriate point during travel, the system activates charging of the primary battery with the DC-DC converter providing electrical power at the voltage boost set point calculated in step 310, utilizing power stored in the deployable flex range batteries to supply electrical energy to charge the primary battery. At step 314, the primary battery is trickle charged through a charging period. At step 316 the process ends. Process 300 is provided as an exemplary process for controlling a flex electronics bay operable to selectively attach a plurality of deployable flex range batteries to an electrical sub-system of a BEV. A number of alternatives to the process are envisioned, and the disclosure is not intended to be limited to the particular examples provided herein.

FIG. 7 schematically illustrates an alternative exemplary embodiment of a flex electronics bay. Flex electronics bay 480 includes a plurality of DC-DC converters 488; flex electronics bay controller 489; a plurality of electronically controllable switches 84, each including a pre-charge circuit 86 configured to bring additional deployable flex range batteries 90 online while minimizing in-rush currents; and a plurality of battery connection terminals 82. An exemplary deployable flex range battery 90 is illustrated including two battery connection post 92 and battery connection post 94 operable to connect with mating details within one of the battery connection terminals 82. In the embodiment of FIG. 7, each battery connection terminal 82 includes a dedicated DC-DC converter 488. In this way different types or configurations of deployable flex range batteries 90 can be attached to flex electronics bay 480. The different type of deployable flex range batteries can include different voltages and/or different internal chemicals with different performance characteristics. Including a separate DC-DC converter 488 for each attached deployable flex range battery 90 enables the flex electronics bay controller 489 to control each battery individually to produce a common voltage to be supplied to a connected electrical sub-system including a primary battery.

According to the embodiment of FIG. 7, each deployable flex range battery 90 is connected to an individual DC/DC converter 488. This configuration enables connection of battery packs with different battery chemistries as compared to the primary battery. Further, the configuration enables controlled charge balancing, power re-circulation between battery packs, and controlled power contribution by each battery pack based on its state of charge to traction. DC/DC converters can alternatively be provided internal to each deployable flex range battery.

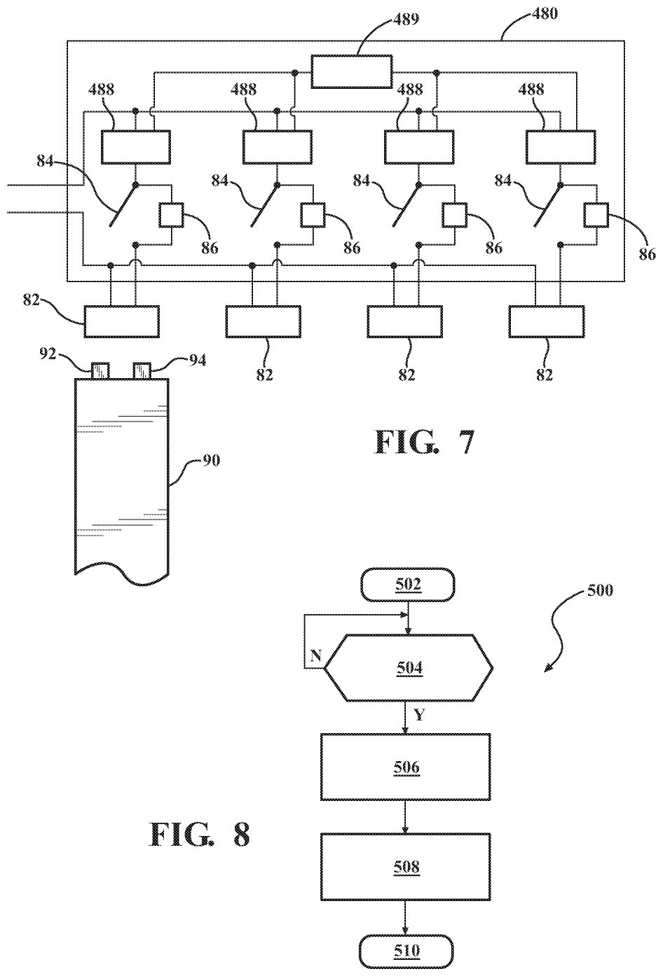

FIG. 8 is a flowchart illustrating an exemplary process to utilize a location of a fast charge infrastructure site to charge a deployable flex range battery with excess charge from a primary battery. Process 500 starts at step 502. At step 504, a determination is made whether a fast charge infrastructure site capable of charging the primary battery of the BEV is available. A fast charge infrastructure site includes a station or charging facility capable of supplying a rapid charge to a primary battery of the BEV. If no fast charge infrastructure site is available or if the user declines to authorize using a site for a charging event, the process returns to step 504 where a fast charge infrastructure site is iteratively searched for. If the fast charge infrastructure site is available and the user of the BEV selects the site for a charging event, the process advances to step 506 where a flex electronics bay controller determines an excess charge available in the primary battery of the BEV in excess of a charge needed to power the BEV to the fast charge infrastructure site. At step 508, the excess charge of the primary battery is utilized to reverse trickle charge one or more deployable flex range batteries on route to the fast charge infrastructure site. At step 510, the process ends. Process 500 illustrates an exemplary process for utilizing excess charge in a primary battery to reverse charge deployable flex range batteries. A number of similar processes are envisioned, and the disclosure is not intended to be limited to the exemplary embodiment provided herein.

A flex electronics bay controller can include programming to determine how much stored energy from attached deployable flex range batteries to use on a particular trip. For example, if the user of the vehicle inputs a destination for a particular trip, the flex electronics bay controller can plan energy usage to make a round trip to and from the destination. If the user or available information indicates that a charging station is available at the destination, the vehicle can instead plan energy usage based upon a one-way trip to the destination, plan on charging at the destination, and plan energy usage based upon returning from the destination. Repeatability of routes of the vehicle can be used to increase confidence in the route and energy usage, for example, if a vehicle is used every day to drive to and from a work location, the vehicle can prompt the user to announce a deviation from the normal route of travel, and in the absence of feedback from the user, schedule energy usage based upon the repeated, normal route of travel. The flex electronics bay controller can schedule reverse charging such as is described in relation to FIG. 8 based upon a repeated or input route, for example, taking advantage of shorter portions of a trip to reverse charge deployable flex range batteries and using stored energy to its fullest potential on longer portions of the trip. In one example, where a flex electronics bay includes six connected deployable flex range batteries, the flex electronics bay controller can utilize three of the deployable flex range batteries on a first portion of a trip and the other three of the deployable flex range batteries on a second portion of the trip.

While the best modes for carrying out the disclosure have been described in detail, those familiar with the art to which this disclosure relates will recognize various alternative designs and embodiments for practicing the disclosure within the scope of the appended claims.

What is claimed is:

1. A system for utilizing a deployable flex range battery to augment a primary battery, comprising:
a flex electronics bay electrically connected to an electrical sub-system comprising the primary battery, the flex electronics bay comprising:
a DC-DC converter operable to change a voltage of electric power; and
at least one battery connection terminal;
the deployable flex range battery removably connected to the at least one battery connection terminal; and
a flex electronics bay controller, programmed to selectively supply electric power from the flex electronics bay to the electrical sub-system.

2. The system of claim 1, further comprising:
a motor generator unit operable to provide a motive force to a battery-powered electric vehicle; and
the electrical sub-system comprising the primary battery operable to supply electric power to the motor generator unit.

3. The system of claim 2, wherein the flex electronics bay comprises a plurality of battery connection terminals; and
wherein the deployable flex range battery comprises a plurality of deployable flex range batteries.

4. The system of claim 3, wherein the flex electronics bay further comprises a plurality of electronically controllable switches each operable to selectively electronically engage and selectively electronically disengage a respective one of the plurality of deployable flex range batteries.

5. The system of claim 4, wherein the flex electronics bay further comprises a plurality of pre-charge circuits, wherein one of the plurality of pre-charge circuits is paired with each of the plurality of electronically controllable switches, the plurality of pre-charge circuits being operable to bring the deployable flex range batteries online while minimizing in-rush currents.

6. The system of claim 4, wherein the flex electronics bay controller further includes programming to:
monitor a status of each of the deployable flex range batteries;
diagnose a malfunction in one of the deployable flex range batteries based upon the monitored status; and
control one of the plurality of electronically controllable switches to selectively disengage the one of the deployable flex range batteries.

7. The system of claim 2, wherein the flex electronics bay controller further includes programming to supply electric power from the flex electronics bay to the electrical sub-system when the battery-powered electric vehicle is parked.

8. The system of claim 2, wherein the flex electronics bay controller further includes programming to supply electric power from the flex electronics bay to the electrical sub-system when the battery-powered electric vehicle is moving.

9. The system of claim 2, wherein the flex electronics bay controller further includes programming to evaluate a state of charge of the primary battery required to operate the battery-powered electric vehicle; and
wherein selectively providing electric power from the flex electronics bay to the electrical sub-system is based upon an evaluation that the state of charge of the primary battery is insufficient to operate the battery-powered electric vehicle.

10. The system of claim 9, wherein evaluating the state of charge of the primary battery required to operate the battery-powered electric vehicle comprises:
monitoring a planned travel destination;
estimating a total travel distance based upon the planned travel destination; and
estimating a state of charge required based upon the total travel distance.

11. The system of claim 10, wherein selectively providing electric power from the flex electronics bay to the electrical sub-system comprises:
utilizing a first portion of a plurality of deployable flex range batteries of the flex electronics bay to supply electric power to the electrical sub-system; and
isolating a second portion of the plurality of deployable flex range batteries of the flex electronics bay for later use.

12. The system of claim 2, wherein the deployable flex range battery comprises a battery management system comprising a computerized device programmed to monitor operation of the deployable flex range battery.

13. The system of claim 2, further comprising a plurality of the deployable flex range batteries, wherein each deployable flex range battery comprises a battery management system comprising a computerized device programmed to monitor operation of the deployable flex range battery and wherein each battery management system is in electronic communication with the flex electronics bay controller.

14. The system of claim 13, wherein each of the battery management system is in wireless electronic communication with the flex electronics bay controller.

15. The system of claim 2, further comprising a plurality of the deployable flex range batteries; and
wherein the flex electronics bay further comprises a plurality of DC-DC converters, wherein each of the plurality of DC-DC converters is paired with one of the plurality of deployable flex range batteries.

16. The system of claim 2, wherein the flex electronics bay controller further includes programming to:
monitor availability of a fast charge infrastructure site;
determine an excess primary battery charge available based upon the monitored availability; and
selectively supplying power from the primary battery to the deployable flex range battery based upon the excess primary battery charge.

17. A system for utilizing a plurality of deployable flex range batteries to augment a primary battery in a battery-powered electric vehicle, comprising:
a motor generator unit operable to provide a motive force to the battery-powered electric vehicle;
an electrical sub-system comprising the primary battery operable to supply electric power to the motor generator unit;
the plurality of deployable flex range batteries, wherein each of the deployable flex range batteries comprises a battery management system comprising a computerized device programmed to monitor operation of the respective deployable flex range battery;
a flex electronics bay electrically connected to the electrical sub-system, the flex electronics bay comprising:
a DC-DC converter operable to change a voltage of electric power;
a plurality of battery connection terminals;
a plurality of electronically controllable switches operable to selectively electronically engage and selectively electronically disengage each of the plurality of deployable flex range batteries; and
a pre-charge circuit for each of the electronically controllable switches, the pre-charge circuits being operable to bring the deployable flex range batteries online while minimizing in-rush currents; and
a flex electronics bay controller, programmed to selectively supply electric power from the flex electronics bay to the electrical sub-system;
wherein each battery management system is in electronic communication with the flex electronics bay controller; and
wherein each of the plurality of deployable flex range batteries is removably connected to one of the plurality of battery connection terminals.

18. A process for utilizing a plurality of deployable flex range batteries to augment a primary battery in a battery-powered electric vehicle, comprising:
supplying electric power from an electrical sub-system comprising the primary battery to a motor generator unit operable to provide a motive force to the battery-powered electric vehicle;
connecting the plurality of deployable flex range batteries to a flex electronics bay of the battery-powered electric vehicle;
within a computerized flex electronics bay controller, operating programming to:
monitor a status of each of the plurality of deployable flex range batteries;
determine a schedule to utilize stored energy within each of the plurality of deployable flex range batteries to supply electric power to the electrical sub-system based upon the monitored statuses; and
selectively supply electric power from the flex electronics bay to the electrical sub-system based upon the schedule.

19. The process of claim 18, wherein determining the schedule to utilize the stored energy comprises determining a schedule to utilize the stored energy from each of the deployable flex range batteries individually.

20. The process of claim 18, wherein the computerized flex electronics bay controller further includes programming to:
diagnose a malfunction in one of the deployable flex range batteries based upon the monitored statuses; and
selectively disengage the one of the deployable flex range batteries.
